(19) United States
(12) Patent Application Publication
(10) Pub. No.: US 2006/0043726 A1
(43) Pub. Date: Mar. 2, 2006

(54) Overlapping binding mechanism

(76) Inventor: Mark P. Schamer, Liberty Township, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/930,467

(22) Filed: Aug. 31, 2004

(51) Int. Cl. B42D 1/00

(52) U.S. Cl. 281/15.1

(57) ABSTRACT

A binding mechanism system including a binding mechanism having a plurality of generally coaxially arranged binding coils, each binding coil including a pair of generally parallel wires terminating in a coil tip, wherein the parallel wires extend around a longitudinal binding axis and define a base portion forming a closed circle and define an overlapping portion, and wherein the overlapping portion has substantially the same center of curvature and substantially the same average radius of curvature as the base portion.

### BACKGROUND

The present invention is directed to a binding mechanism and, more particularly, to a twin-wire binding mechanism.

Binding mechanisms, such as coil and twin-wire type binding mechanisms, typically are used to bind a plurality of sheets of paper together to form a notebook. Such binding mechanisms may also be used to bind polymeric sleeves together to form photo albums and to secure various covers and folders to form notebooks and the like.

A typical twin-wire binding mechanism is made from a metal wire and shaped to form a number of coils. Each coil is received within a corresponding binding hole positioned along a binding edge of a notebook or the like to bind the components of the notebook together.

However, typical twin-wire binding mechanisms do not form a completely closed coil. Instead, a gap is formed in the coil which allows papers to be partially or fully separated from the coil. Accordingly, there is a need for a twin-wire binding mechanism that prevents bound items from escaping from the binding mechanism.

### SUMMARY

A first embodiment of the present invention provides a binding mechanism system including a binding mechanism having a plurality of generally coaxially arranged binding coils, each binding coil including a pair of generally parallel wires terminating in a coil tip, wherein the parallel wires extend around a longitudinal binding axis and define a base portion forming a closed circle and define an overlapping portion, and wherein the overlapping portion has substantially the same center of curvature and substantially the same radius of curvature as the base portion.

A second embodiment of the present invention provides a binding mechanism system including a binding mechanism having a plurality of generally coaxially arranged binding coils, each binding coil extending around a longitudinal binding axis to form a closed circle and including a pair of generally parallel wires terminating in a coil tip, wherein each binding coil includes an indented portion located at or adjacent to the coil tip.

Other embodiments, objects, features and advantages of the present invention will become apparent to those skilled in the art from the detailed description, the accompanying drawings and the appended claims.

### BRIEF DESCRIPTION OF THE DRAWINGS

The invention may be understood with reference to the following drawings. In the drawings, like reference numerals designate corresponding parts throughout the several views. Furthermore, the components in the drawings are not necessarily to scale.

FIG. 1 is a front perspective view of a portion of one embodiment of the binding mechanism of the present invention;

FIG. 2 is an end view of the binding mechanism of FIG. 1;

FIG. 3 is a top view of the binding mechanism of FIG. 1 prior to being formed into a coil;

FIG. 4A is a side elevational view of a notebook receiving a partially formed binding mechanism therethrough;

FIG. 4B is a side elevational view of the notebook of FIG. 4A after formation of the binding coils;

FIG. 5 is a top plan view of the notebook of FIG. 4B;

FIG. 6A is a top plan view of a portion of the binding mechanism of the present invention prior to complete formation of the binding coils;

FIG. 6B is a top plan view of the binding mechanism of FIG. 6A after formation of the binding coils;

FIG. 6C is an end view of the binding mechanism of FIG. 6B; and

FIG. 7 is a front perspective view of the binding mechanism of FIG. 6B.

### DETAILED DESCRIPTION

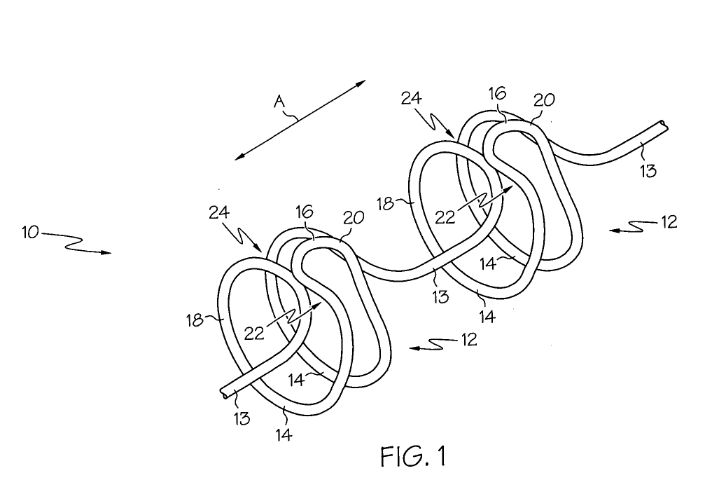

As shown in FIG. 1, a binding mechanism according to the present invention, generally designated 10, includes a plurality of binding coils 12 coaxially arranged or aligned along a longitudinal binding axis A. Each binding coil 12 is connected to any adjacent binding coil(s) 12 by a connecting portions 13 that extends generally parallel to the binding axis A. Each binding coil 12 includes a pair of generally parallel wires or wire portions 14 that terminate in a coil tip 16 where the parallel wire portions 14 meet. Each binding coil 12 and its associated wire portions 14 define a receiving portion 24 between each pair of parallel wires 14 at or near the adjacent connecting portions 13.

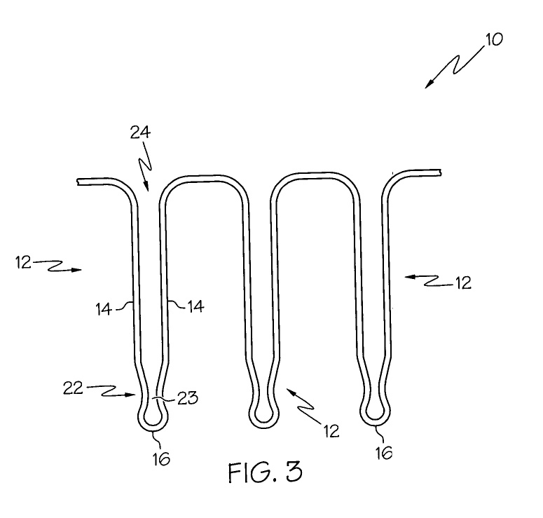

The binding mechanism 10 may be constructed from a single unitary piece of material, such as plastic or metal wire, and may have a thickness (i.e., diameter) of between about 0.2 mm and about 2 mm. The material selected for the binding mechanism 10 may be capable of being formed or shaped such that the binding mechanism 10 shown in the form of FIG. 3 may be formed and subsequently curled into the shape of the binding mechanism 10 shown in FIG. 1.

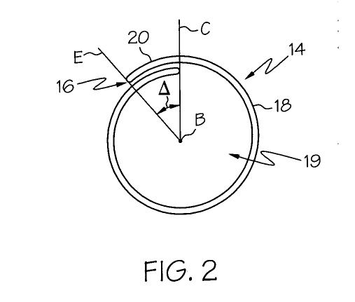

Each pair of parallel wires 14 is wrapped around a center of curvature B that extends parallel with the longitudinal axis A to form a binding coil 12. In the embodiment shown in FIG. 2, the wires 14 form a base portion 18 having a generally circular shape in end view that extends approximately 360 radial degrees and an overlapping portion 20 that overlaps the base portion 18.

The overlapping portion 20 radially overlaps, and smoothly conforms to, the base portion 18 such that the overlapping portion has generally the same center of curvature and generally the same average radius of curvature as the generally closed circle 19 formed by the base portion 18. The overlapping portion 20 of each binding coil 12 is located at approximately the same longitudinal (axial) position as the associated base portion 18. The overlapping portion 20 begins at a ray C (where the overlap begins) and ends at a ray E (where the tip 16 is located). Rays C and E extend from the center of curvature B and the angle between rays C and E defines the degree of overlap Δ. By indicating that the base portion 18 and overlapping portion 20 “radially overlap” it is meant that a line or ray extending radially outward from the center of curvature B intersects both the base portion 18 (at a first radial distance) and the overlapping portion 20 (at the first radial distance or at a second radial distance) throughout the degree of overlap Δ. In the embodiment shown in FIG. 2, the overlapping portion 20 is located slightly radially outwardly of the overlapped base portion 18. However, as will be discussed below, the overlapping portion 20 may be aligned with the base portion 18. Further alternately, the overlapping portion 20 may be located slightly radially inwardly of the base portion 18

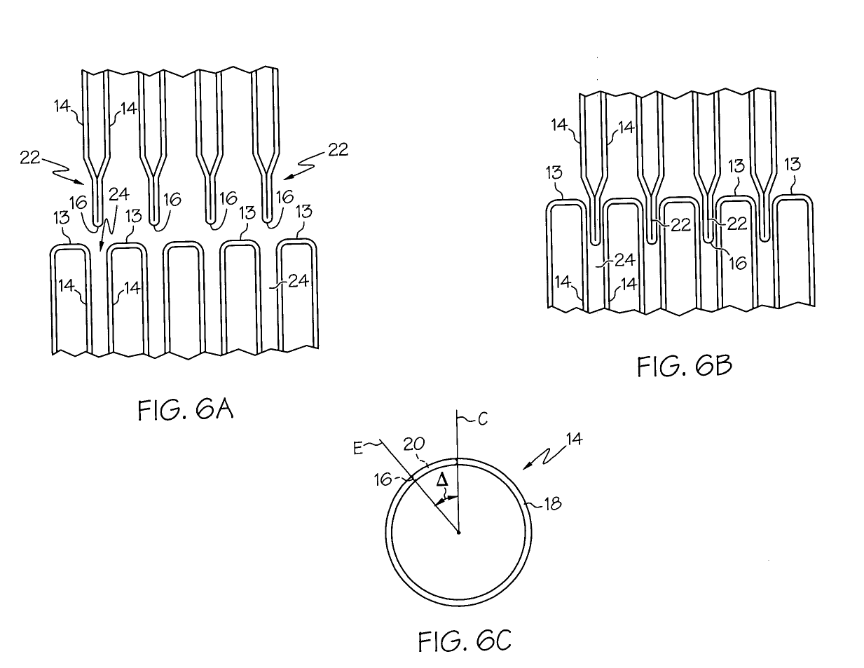

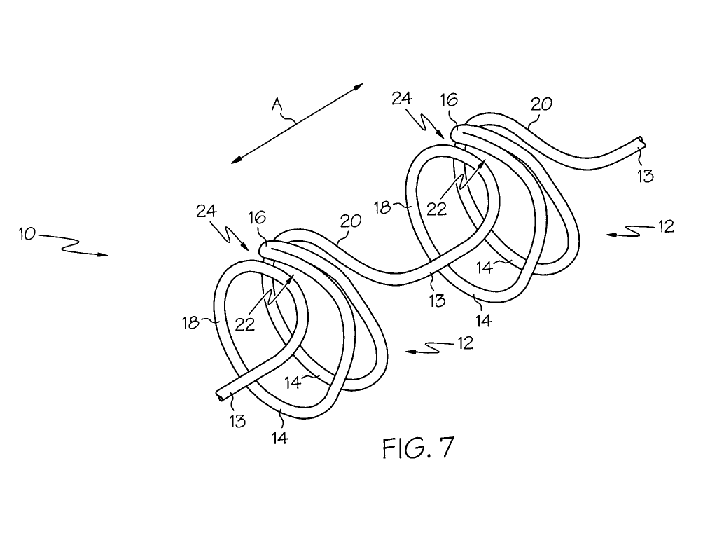

In the embodiment shown in FIGS. 6A, 6B, 6C and 7, the overlapping portion 20 is generally radially aligned with the base portion 18. In particular, the overlapping portion 20 may be generally fully received within the associated receiving portion 24 (FIG. 6B), thereby allowing the coil 12 to form a generally closed circle-shaped base portion 18, wherein the overlapping portion 20 and the base portion 18 have generally the same center of curvature and generally the same radius of curvature (FIG. 6C).

In the embodiments shown in FIG. 2 and FIG. 6C, as well as other embodiments, the difference between the average radius of curvature of the closed circle 19 and the average radius of curvature of the overlapping portion 20 may be no more than about 2 mm, or no more than the thickness or diameter of the binding wire, or no more than about 10 times the thickness or diameter of the binding wire. The distance between the center of curvature B of the closed circle 19 and the center of curvature of the overlapping portion 20 may be no more than about 2 mm, or no more or no more than the thickness or diameter of the binding wire, or no more than about 10 times the thickness or diameter of the binding wire.

The closed circle 19 formed by the base portion 18 may have a diameter ranging from about ¼ inch to about 3 inches. The overlapping portion 20 may overlap the base portion 18 anywhere from about 1 degree to about 90 degrees and, preferably, between about 10 and about 40 degrees. According to one embodiment, the length of the overlapping portion 20 is at least 5 mm. The length L of the overlapping portion 20 is a function of the degree of overlap Δ and the diameter D of the closed circle 19 and may be determined as follows:
L=πDΔ/360

For example, a base portion 18 forming a generally closed circle 19 having a diameter of 1 inch and an overlapping portion 20 that overlaps the base portion 18 by 20° would have a length of overlap of about 0.17 inches.

Each overlapping portion 20 may include an indented portion or narrowed 22 positioned at or near the tip 16, as shown in FIG. 3. At the indented or narrowed portion 22, the space 23 between the wires 14 may be less than or equal to the thickness of a wire 14, or less than or equal to twice the thickness of the wire 14. The space 23 may also have various other widths and the wires 14 at the tip 16 may also be pressed together, in which case there is no space 23. Alternatively, the tip 16 may be tapered such that the space between the wires 14 decreases as the wires 14 approach the tip 16. Further alternately, part or all of the overlapping portion 20 may be narrowed or pressed together to form the narrowed portion 22 shown in FIGS. 6A, 6B and 7. In this embodiment the narrowed portion 22 extends generally perpendicular to the binding axis A. The narrowed portion 22 may allow the tip 16 and portions of the wires 14 to fit inside the associated receiving portion 24.

When the overlapping portion 20 radially overlaps the base portion 18 (e.g., as best shown in FIG. 2), the distance between the base portion 18 and the overlapping portion 20 may be less than about the width of the wire 14, or less than about twice the width of the wire 14, or less than about three times the width of the wire 14, or less than about four times the width of the wire 14, for the entire length of the overlapping portion 20. The distance between the base portion 18 and the overlapping portion 20 preferably remains substantially constant throughout the degree of overlap Δ. This distance may change by less than about 10% or less than about 20% or less than about 30%, or less than about 40% or less than about 50% along the length of the overlapping portion 20. By ensuring that the distance between the base portion and the overlapping portion remains relatively small and relatively constant, it is ensured that the overlapping portion conforms closely to the base portion. This ensures that the overlapping portion does not flare away from the base portion in a tangential direction, and reduces the chances of the overlapping portion catching or snagging on loose components (i.e. clothing, fabric, backpacks, straps, etc.)

The binding coils 12 may not necessarily be circular in end view, but may take other (preferably closed) shapes in end view. For example, the base portion 18 may be generally oval, generally D-shaped or various other non-circular shapes. Regardless of the shape of the base portion 18, the overlapping portion 20 may still “radially” overlap, and smoothly conform to, the shape of the base portion 18 and/or be received within the receiving portion 24. Furthermore, when the overlapping portion 20 overlaps the base portion 18, the distance between the overlapping portion 20 and the base portion 18 preferably remains substantially constant and small throughout the length of the overlap.

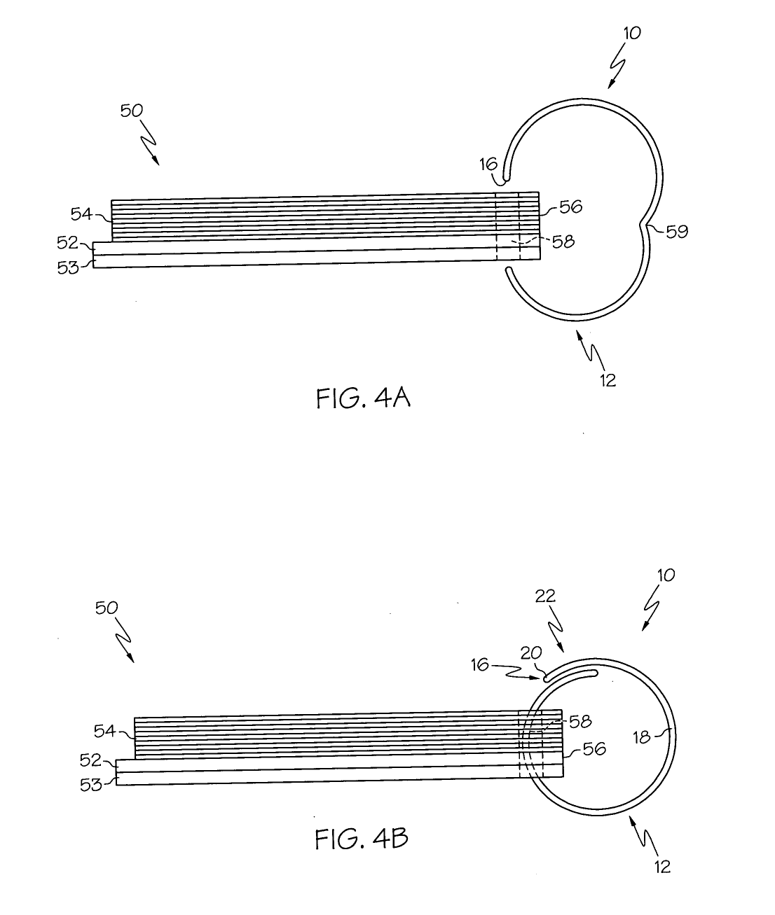

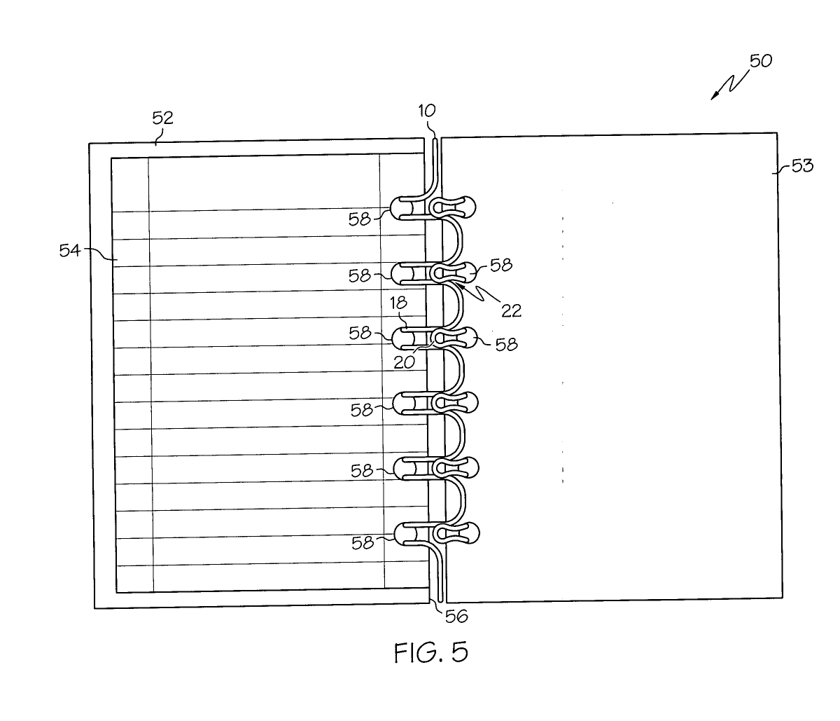

As shown in FIGS. 4A, 4B and 5, a notebook 50 having a front cover 52, a back cover 53 and a plurality of sheets of paper 54 can be formed and bound by the binding mechanism 10. The front cover 52, back cover 53 and plurality of sheets of paper 54 each include a binding edge 56 and a plurality of openings 58 extending along the associated binding edge 56. The plurality of openings 58 are aligned, shaped and arranged to receive the binding mechanism 10 therethrough, as shown in FIG. 4A. In order to bind the notebook 50, the binding mechanism 10 is shaped, from its flat or unfolded position shown in FIG. 3, into the partially formed position shown in FIG. 4A. In the partially formed position, each coil is generally C-shaped and includes an hinged portion 59. Each partially formed coil 12 of the binding mechanism 10 is then aligned with its corresponding hole 58 in the front cover 52, back cover 53 and plurality of sheets of paper 54 and each partially formed coil is clamped or closed (via rotation at the hinge 59), to form the closed coil shown in FIG. 4B. In the closed coil position, the base portion 18 forms a generally closed circle 19 and an overlapping portion 20, thereby securing the front cover 52, back cover 53 and plurality of sheets of paper 54 together along the binding edge 56 (see FIGS. 4B and 5). The overlapping portion 20 eliminates any openings in the coil 12 and traps the components 52, 53, 54 therein as compared to prior art designs lacking the overlapping portion 20.

Although the invention is shown and described with respect to certain embodiments, it is obvious that equivalents and modifications will occur to those skilled in the art upon reading and understanding this specification and the appended claims. The present invention includes all such equivalents and modifications and is limited only by the scope of the claims.

What is claimed is:

1. A binding mechanism system comprising a binding mechanism having a plurality of generally coaxially arranged binding coils, each binding coil including a pair of generally parallel wires terminating in a tip, wherein said parallel wires extend around a longitudinal binding axis and define a base portion forming a generally closed circle and define an overlapping portion that overlaps with said base portion, and wherein said overlapping portion has substantially the same center of curvature and substantially the same average radius of curvature as said base portion.

2. The binding mechanism system of claim 1 wherein said overlapping portion of each binding coil extends at least about 10 degrees.

3. The binding mechanism system of claim 1 wherein said overlapping portion of each binding coil has a length of at least about 5 mm.

4. The binding mechanism system of claim 1 wherein a difference between a center of curvature of said generally closed circle and a center of curvature of said overlapping portion of each binding coil is no more than about 2 millimeters.

5. The binding mechanism system of claim 1 wherein a difference between an average radius of curvature of said generally closed circle and an average radius of curvature of said overlapping portion of each binding coil is no more than about 2 millimeters.

6. The binding mechanism system of claim 1 wherein said base portion of each binding coil defines a receiving portion located between said wires, and wherein said overlapping portion is positioned in an associated receiving portion.

7. The binding mechanism of claim 1 wherein each overlapping portion includes a narrow portion that is narrower than the associated base portion.

8. The binding mechanism of claim 7 wherein each narrow portion terminates in said coil tip.

9. The binding mechanism system of claim 7 wherein each narrow portion is located at or adjacent to said coil tip.

10. The binding mechanism system of claim 7 wherein, at each narrow portion, said wires are located within at least a width of said wire of each other.

11. The binding mechanism system of claim 1 further comprising a plurality of connection portions extending generally parallel to said binding axis and coupled to adjacent ones of said binding coils.

12. The binding mechanism system of claim 11 wherein each binding coil and said plurality of connection portions are formed of a single, unitary piece of material.

13. The binding mechanism system of claim 11 wherein said single, unitary piece of material is a plastic or metal wire having a diameter of between about 0.2 mm and about 2 mm.

14. The binding mechanism system of claim 1 further comprising a plurality of papers having a set of openings therein, each opening receiving one of said binding coils therethrough such that said binding mechanism binds said plurality of papers together.

15. The binding mechanism system of claim 1 wherein said base portion and the associated overlapping portion are both located at substantially a same longitudinal location along said longitudinal binding axis.

16. A binding mechanism system comprising a binding mechanism having a plurality of generally coaxially arranged binding coils, each binding coil extending around a longitudinal binding axis to form a generally closed shape and including a pair of generally parallel wires terminating in a tip, wherein each binding coil includes a narrow portion located at or adjacent to said tip.

17. The binding mechanism system of claim 16 wherein, at each narrow portion, said wires are located within at least a width of said wire of each other.

18. The binding mechanism of claim 16, wherein, at each narrow portion said wires are pressed together.

19. The binding mechanism system of claim 16 wherein each binding coil has a generally circular base portion and a generally curved overlapping portion overlapping with said base portion in a radial direction.

20. The binding mechanism system of claim 19 wherein said overlapping portion of each binding coil has substantially the same center of curvature and substantially the same average radius of curvature as the associated base portion.

21. The binding mechanism system of claim 19 wherein said overlapping portion of each binding coil extends at least about 10 degrees.

22. The binding mechanism system of claim 19 wherein said base portion of each binding coil defines a receiving portion located between said wires, and wherein each narrow portion is positioned in an associated receiving portion.

23. The binding mechanism system of claim 16 further comprising a plurality of connection portions extending generally parallel to said binding axis and coupled to adjacent ones of said binding coils.

24. The binding mechanism system of claim 23 wherein each binding coil and said plurality of connection portions are formed of a single, unitary piece of material.

25. The binding mechanism system of claim 24 wherein said single, unitary piece of material is a plastic or metal wire having a diameter of between about 0.2 mm and about 2 mm.

26. The binding mechanism system of claim 16 further comprising a plurality of papers having a set of openings therein, each opening receiving one of said binding coils therethrough such that said binding mechanism binds said plurality of papers together.

27. The binding mechanism system of claim 16 wherein said base portion and the associated overlapping portion are both located at substantially a same longitudinal location along said longitudinal binding axis.

28. The binding mechanism of claim 16 wherein said narrow portion is oriented generally perpendicular to said longitudinal binding axis.

29. A binding mechanism system comprising a binding mechanism having a plurality of generally aligned binding coils, each binding coil including a pair of generally parallel wires terminating in a coil tip, wherein said parallel wires define a generally closed base portion and define an overlapping portion that overlaps said base portion and has a shape generally conforming to the shape of an overlapped portion of said base portion, and wherein a distance between said overlapping portion and said base portion is substantially constant along the entire length of said overlapping portion.

30. The binding mechanism system of claim 29 wherein said base portion of each binding coil is generally circular in end view and said overlapping portion of each binding coil extends at least about 10 degrees.

31. The binding mechanism system of claim 29 wherein said distance between said-base portion and the associated overlapping portion is less than or equal to two times the thickness of said wires along the entire length of said overlapping portion for each binding coil.

32. The binding mechanism system of claim 29 wherein said base portion of each binding coil defines a receiving portion located between said wires, and wherein each overlapping portion is positioned in an associated receiving portion.

33. The binding mechanism of claim 29 wherein each overlapping portion terminates in said coil tip.

34. The binding mechanism system of claim 33 wherein each coil includes a narrow portion at or adjacent to said coil tip.

35. The binding mechanism system of claim 33 wherein, at each narrow portion, said wires are located within at least a width of said wire of each other.

36. The binding mechanism system of claim 29 further comprising a plurality of connection portions extending generally parallel to said binding axis and coupled to adjacent ones of said binding coils.

37. The binding mechanism system of claim 36 wherein each binding coil and said plurality of connection portions are formed of a single, unitary piece of material.

38. The binding mechanism system of claim 37 wherein said single, unitary piece of material is a plastic or metal wire having a diameter of between about 0.2 mm and about 2 mm.

39. The binding mechanism system of claim 29 further comprising a plurality of papers having a set of openings therein, each opening receiving one of said binding coils therethrough such that said binding mechanism binds said plurality of papers together.

40. The binding mechanism system of claim 29 wherein said base portion and said overlapping portion are both located at substantially a same longitudinal location along said longitudinal binding axis.
